(19) United States
(12) Patent Application Publication
(10) Pub. No.: US 2017/0058571 A1
(43) Pub. Date: Mar. 2, 2017

(54) BAR LOCK

(71) Applicant: RICHARD CARLSON WILLIS, BOERNE, TX (US)

(72) Inventor: RICHARD CARLSON WILLIS, BOERNE, TX (US)

(21) Appl. No.: 15/252,348

(22) Filed: Aug. 31, 2016

Related U.S. Application Data
(60) Provisional application No. 62/211,870, filed on Aug. 31, 2015.

(51) Int. Cl. E05B 73/00; A01M 31/02; E05B 67/38

(52) U.S. Cl. CPC E05B 73/00; E05B 67/383; E05B 67/38; A01M 31/025

(57) ABSTRACT

A locking device characterized as having a U-shape. The U-shape device has two arms and a connecting section. The proximal ends of each arm are connected to the connecting section. The distal end of each arm comprises an aperture. The connecting section is angled along a different plane than the arms.

### CROSS REFERENCES TO RELATED APPLICATION

This application claims the benefit of and priority to U.S. Provisional Application Ser. No. 62/211,870 filed Aug. 31, 2015 and entitled “Bar Lock,” which is incorporated by reference herein.

### FEDERALLY SPONSORED RESEARCH OR DEVELOPMENT

Not applicable.

### BACKGROUND OF THE INVENTION

1. Field of the Invention

The present invention relates generally to mechanical locks and security mechanisms.

2. Description of the Related Art

Traditional locks often work well to secure a door or similar object in place in order to prevent access, but such locks do not work well for securing rods to a central hub. The present invention eliminates this problem.

Additionally, the popularity of portable hunting blinds has increased with the development of easy-to-assemble and easy-to-disassemble units. The devices are typically made easy to assemble and disassemble by hubs located in the center of each wall and the roof of the structure. Each hub typically holds four rods that disperse to the four corners of the respective wall. When force is applied appropriately, the structure can assemble or disassemble in a matter of moments. A negative consequence, however, is that such devices are relatively easy for thieves to steal when left unattended. The present invention is intended prevent disassembly by someone other than the owner of the blind.

### BRIEF SUMMARY OF THE INVENTION

A locking device characterized as having a U-shape. The U-shape device has two arms and a connecting section. The proximal ends of each arm are connected to the connecting section. The distal end of each arm comprises an aperture. The connecting section is angled along a different plane than the arms.

### BRIEF DESCRIPTION OF THE SEVERAL VIEWS OF THE DRAWINGS

FIG. 1 is a perspective view of a first embodiment of the present invention.

FIG. 2 is a top plan view thereof.

FIG. 3 is a right side plan view thereof.

FIG. 4 is a bottom plan view thereof.

FIG. 5 is an environmental view of a hub and multiple rods that can be secured with the present invention.

FIG. 6 is a bottom plan view of the first embodiment of the present invention as disclosed in FIGS. 1-4 positioned along a hub and multiple rods without a lock.

FIG. 7 is a bottom plan view of the first embodiment of the present invention as disclosed in FIGS. 1-4 positioned along a hub and multiple rods with a lock to secure the embodied invention to the hub and rods.

FIG. 8 is a bottom plan view of the first embodiment of the present invention as disclosed in FIGS. 1-4 positioned along a hub and multiple rods with a lock to secure the embodied invention to multiple rods.

### DETAILED DESCRIPTION OF THE INVENTION

The following is a description of the preferred embodiments of a bar locking device that can be easily positioned around one or more hubs, rods and the like, and with the addition of a lock (e.g., pad lock), secure the hub(s) and rod(s) in place.

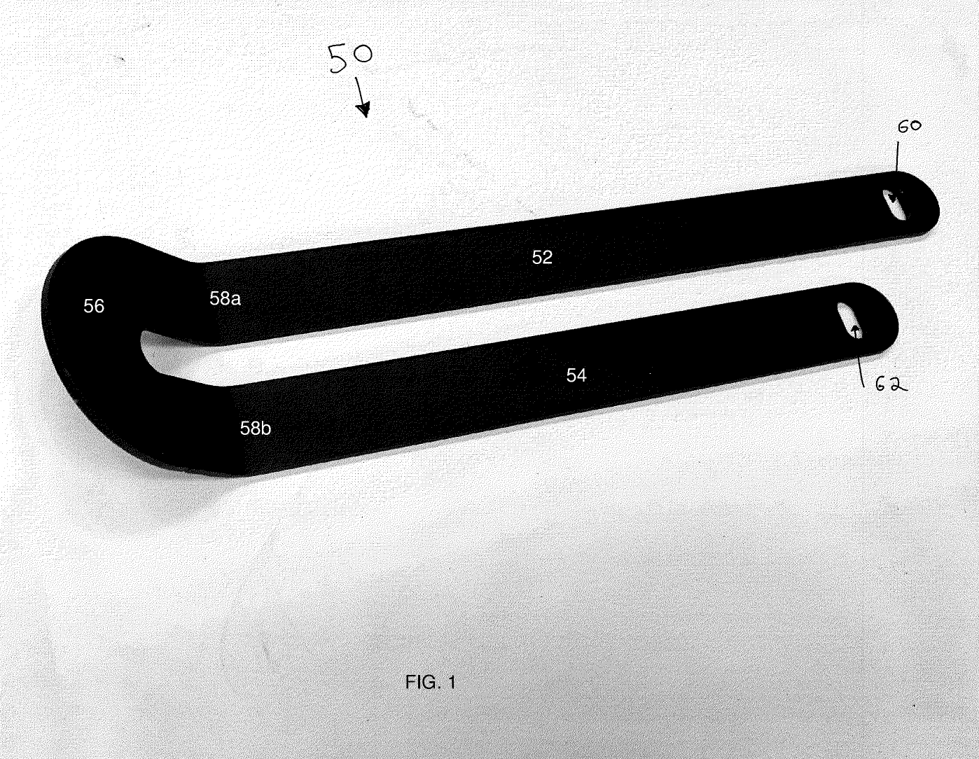

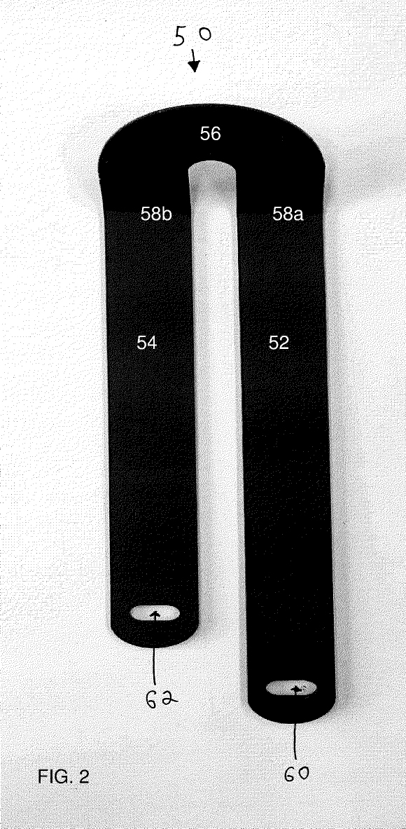

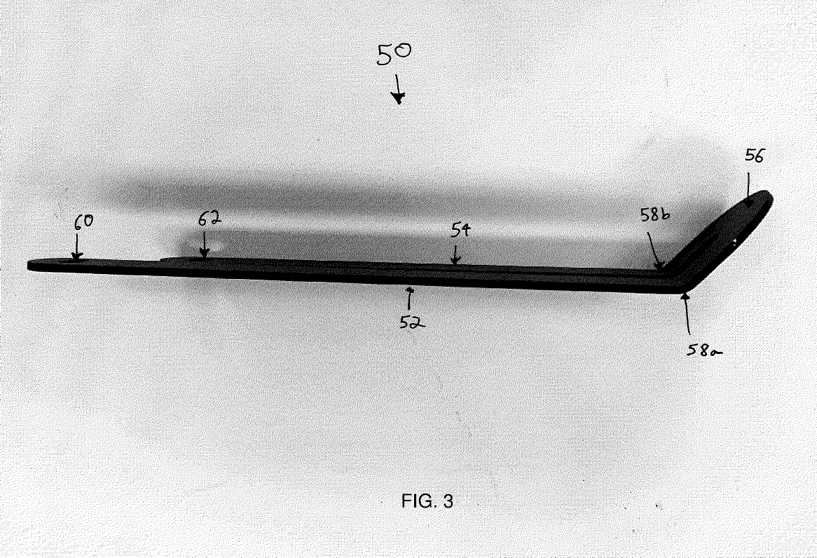

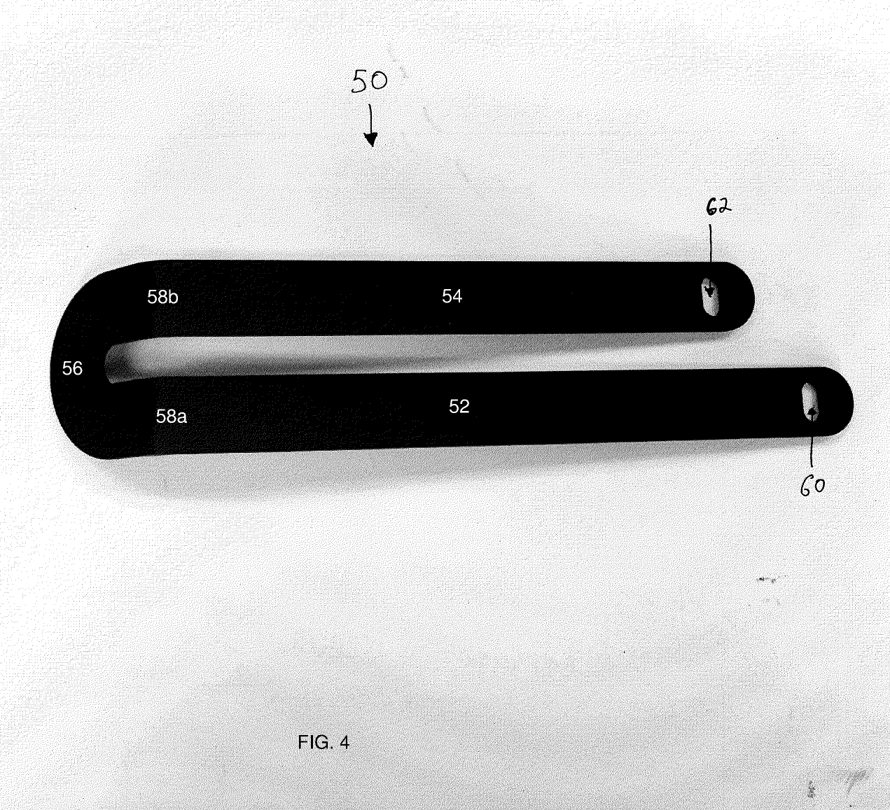

FIGS. 1-4 illustrate different views of an embodiment of the bar lock 50. This embodiment of the bar lock 50 is characterized by having a first arm 52 and a second arm 54—the two arms connected by a connecting section 56 at proximal ends of the first arm 52 and the second arm 54. In this embodiment, the connecting section 56 angles at first crease 58a and at second crease 58b into a different plane than the first arm 52 and the second arm 54, which are parallel to one another. At the distal end of the first arm 52 is a first aperture 60. Similarly, at the distal end of the second arm 54 is a second aperture 62.

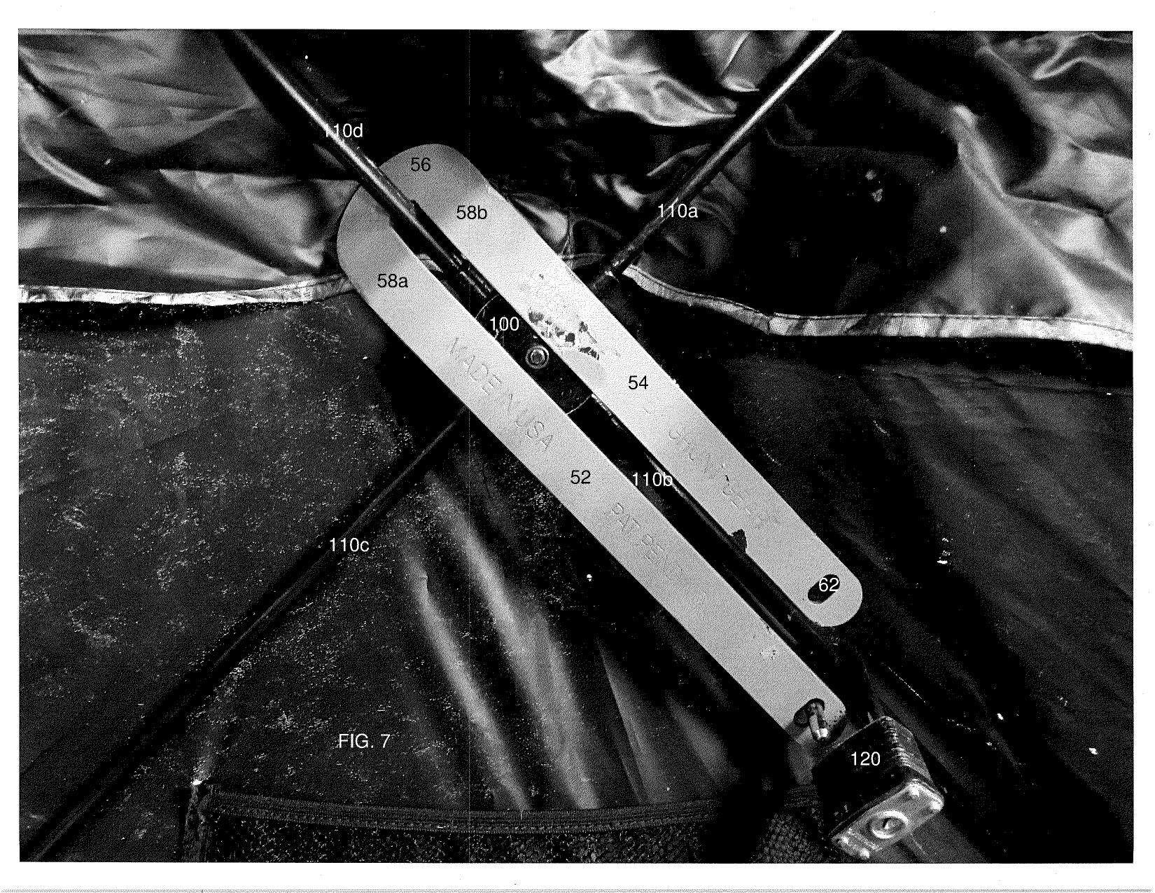

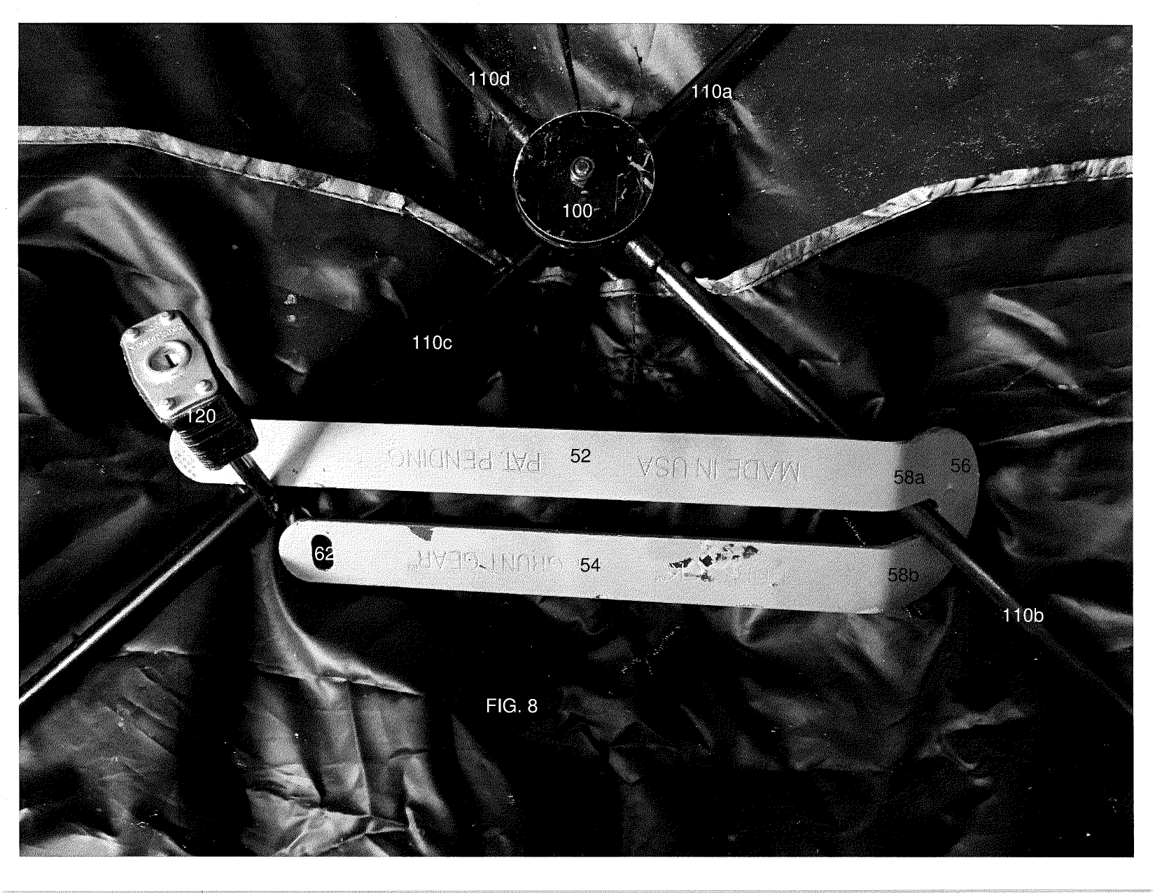

The first aperture 60 and the second aperture 62 are large enough for the shackle of a padlock or other desired lock to pass through—as illustrated in FIGS. 7 and 8 below.

In this particular embodiment, the first arm 52 is longer than the second arm 54 in order to potentially accommodate a wider variety of hub and rod configurations. For example, the dimensions of the bar lock 50 as described in this embodiment are approximately as follows: 10-12 inches long; 2.5 inches wide (total) or 1 inch per arm; and 1.5 inches tall (from bottom of arms to top of the connecting section). Of course, these dimensions can vary—both proportionally and not. Additionally, making one of the arms longer than the other arm may make securing the shackle of a lock easier to accomplish—as the shorter arm is not in the way. This feature should not be construed as limiting. In other embodiments, the first arm 52 and the second arm 54 may be the same length and still remain within the contemplation of the present invention.

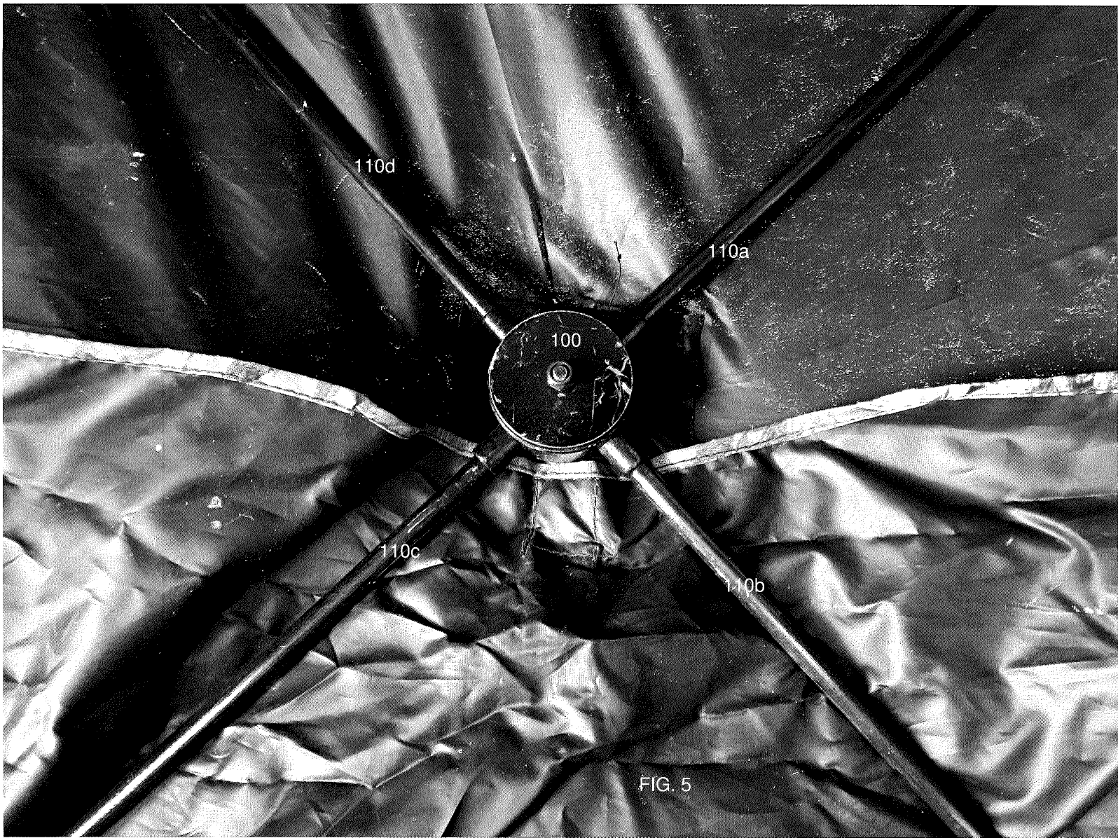

FIG. 5 shows one environment for using the present invention—the hub 100 of a portable deer blind with two or more collapsible rods 110a, 110b, 110c, 110d. As mentioned above, the popularity of portable hunting blinds has increased with the development of easy-to-assemble and easy-to-disassemble units. A negative consequences, however, is that the devices are relatively easy for thieves to steal when left unattended. One of ordinary skill in the art will recognize that the present invention is not limited in application to the environment described herein.

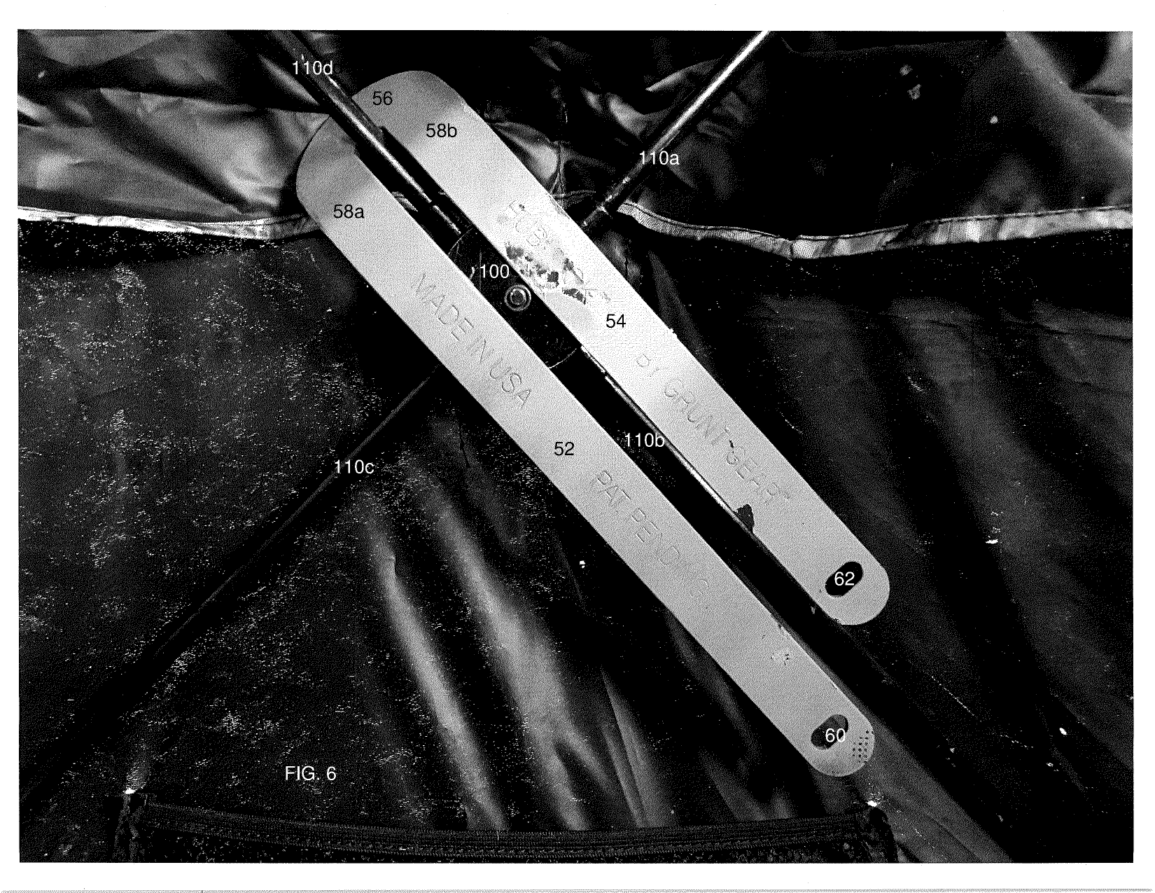

FIG. 6 shows the embodiment of the invention described above positioned in a preferred manner across a hub 100 and rods 110b, 110d opposite the hub 100—before securing the bar lock 50 with a lock—illustrated in FIG. 7. When using this embodiment of the invention in this environment, the distal ends of the first arm 52 and the second arm 54 are pulled passed a rod 110d toward the hub 100 and further toward an opposite rod 110b such that the initial rod 110d and hub 100 catch the bar lock 50 and keep the bar lock 50 from moving further. FIG. 6 illustrates the need for the connecting section 56 to bend and/or extend far enough away from the plane containing the first arm 52 and the second arm 54 for the connecting section 56 to rest beneath the rod 110d and for the first arm 52 and the second arm 54 to rest above the hub 100. Although the embodiment here illustrates the plane containing the connecting section 56 intersecting the plane containing the first arm 52 and the second arm 54 at a forty-five degree angle) (45°) relative to the plane containing the first arm 52 and the second arm 54, this feature should not be construed as limiting. In alternative embodiments, the angle of intersection between the plane containing the connecting section 56 and the plane containing the first arm 52 and the second arm 54 might be less than forty-five degrees and in others the angle of intersection might be more, including ninety degrees. It is expected this angle will be more than zero degrees and less than one hundred and eighty degrees—preferably between thirty degrees and one hundred fifty degrees.

Although not shown here, someone using the bar lock 50 might prefer to use a lock with a shackle that spans the first aperture 60 and the second aperture 62 such that the lock closes the gap between the first arm 52 and the second arm 54—preventing someone from removing the bar lock 50 from the hub configuration without removing the lock.

FIG. 7 illustrates the embodiment of FIG. 6 with the addition of a lock 120. The lock 120 comprises a shackle that circumscribes a rod 110b and the first aperture 60. If the shackle was secured in the lock 120 the bar lock 50 would remain generally fixed to the rods 110b, 110d and hub 100. Of course, a certain degree of translational movement along the rods 110b, 110d might occur; but the bar lock 50 could not be removed completely without removing the lock 120. Because the bar lock 50 cannot be removed at this point, a thief could not collapse the rods 110a, 110b, 110c, 110d on the hub 100 without picking or removing the lock 120. The bar lock 50 also provides the additional benefit of adding stability to the hub configuration. If snow or other matter accumulates on the roof of a hunting blind, the hunting blind often and easily caves in. The bar lock 50 provides additional reinforcement and strength to the structural integrity of the hunting blind. With the addition of the bar lock 50 more weight is required for a cave-in.

FIG. 8 shows an alternative locking configuration. Where FIG. 7 shows use of the bar lock 50 across rods 110b, 110d opposite the hub 100, FIG. 8 shows use of the bar lock 50 across adjacent rods 110b, 110c without using the hub 100. This use exemplifies one benefit of the first arm 52 being longer than the second arm 54: alternative distances for the bar lock 50 to span the rods 110b, 110d. In some situations, it might be preferential for a longer arm to span the adjacent rods. In other situations, the user might prefer the shorter arm. By using disparate arm lengths, the user attains versatility.

The present invention is not limited in use to hunting blinds. Its application may be extended to other situations where one or more rods need to be secured either together or across a hub: and those one or more rods need not be perpendicular to one another. Also, application of the present invention does not require four rods. This device may be used with one or more rods. Similarly, alternative embodiments of the device might comprise a connecting section that is not rounded or that forms a curved, rather than linear plane. Other embodiments might comprise more than two arms. In those embodiments, the connecting section might catch on one rod and the plurality of arms extend to a plurality of rods—perhaps forming a T, L or +shape. Also, other embodiments need not contain two or more apertures. As illustrated in the accompanying drawings, the present invention functions when only a single aperture is relied on. Another embodiment might include first and second arms that significantly differ in length or, alternatively, are the same length. In other embodiments, the first arm and the second arm are not necessarily parallel.

In certain embodiments, this invention is made of thorough material which may include metal, plastic, fiberglass, or a number of other materials. It will be appreciated by persons in the art and numerous variations and/or modifications may be made to the invention as shown in the specific embodiments without departing from the spirit or scope of the invention as broadly described. The present embodiments are therefore, to be considered in all respects illustrative and not restrictive. Other features and aspects of this invention will be appreciated by those skilled in the art upon reading and comprehending the disclosure. Such features, aspects, and variations and modifications of the reported results are examples clearly within the scope of the invention where the invention is limited solely by the scope of the following claims.

1. A locking device comprising:
a first arm comprising a first proximal end and a first distal end;
a second arm comprising a second proximal end and a second distal end;
a middle member connecting said first proximal end and said second proximal end; and
a first aperture positioned at a location between said first proximal end and the first distal end.

2. The locking device of claim 1 wherein said middle member is positioned at a first angle relative to said first arm.

3. The locking device of claim 2 wherein said first angle is in said range of about 30-150 degrees relative to said first arm.

4. The locking device of claim 1 further comprising a second aperture positioned at a location between said second proximal end and said second distal end.

5. The locking device of claim 1 wherein said first arm is longer than said second arm.

6. The locking device of claim 1 wherein said first arm and said second arm are of equal length.

7. The locking device of claim 1 wherein said first arm and said second arm are parallel.

8. The locking device of claim 1 wherein said middle member forms a semi-circular configuration.

9. The locking device of claim 8 wherein said middle member comprises a first annular space.

10. The locking device of claim 1 wherein said first arm and said second arm are perpendicular.

11. The locking device of claim 10 wherein said second arm comprises a second aperture positioned at a location between said second proximal end and said second distal end.

12. The locking device of claim 11 wherein further comprising a third arm comprising a third proximal end, a third distal end, and a third aperture positioned at a location between said third proximal end and said third distal end.
